(19) United States
(12) Patent Application Publication
(10) Pub. No.: US 2026/0044168 A1
(43) Pub. Date: Feb. 12, 2026

(54) REFERENCE CIRCUIT

(71) Applicant: MEDIATEK INC., Hsinchu City (TW)

(72) Inventors: Albert Yen-Chih CHIOU, Hsinchu City (TW); Ching-Tzung LIN, Hsinchu City (TW)

(21) Appl. No.: 18/797,961

(22) Filed: Aug. 8, 2024

(51) Int. Cl. G05F 3/26

(52) U.S. Cl. CPC G05F 3/262

(57) ABSTRACT

A reference circuit is provided. A first first-type MOS device is coupled between a first node and a ground and has a control terminal coupled to the first node. A second first-type MOS device is coupled between a second node and a third node and has a control terminal coupled to the first node. A resistive element is coupled between the third node and the ground. First and second second-type MOS devices are coupled between a voltage supply terminal and the first and second nodes. A first threshold voltage of the first first-type MOS device is greater than a second threshold voltage of the second first-type MOS device. Difference between a slope representing variation of the first threshold voltage over temperature and a slope representing variation of the second threshold voltage over temperature is substantially constant. A reference voltage is generated from the third node.

### BACKGROUND OF THE INVENTION

### Field of the Invention

The invention relates to a reference circuit which generates a reference voltage or current insensitive to temperature.

### Description of the Related Art

A reference circuit operates to generate a reference voltage or current that is used as a base voltage or current for operations of other circuits. Ideally, a reference voltage or current should not be affected by temperature. However, due to characteristics of components in a reference circuit, the generated reference voltage or current will increase or decrease with increment of temperature, which will cause the other circuits to operate abnormally. Therefore, it is desirable to provide a reference circuit that can generate a reference voltage or current independent to temperature.

### BRIEF SUMMARY OF THE INVENTION

An exemplary embodiment of a reference circuit is provided. The reference circuit comprises a first first-type metal-oxide-semiconductor (MOS) device, a second first-type MOS device, a first resistive element, a first second-type MOS device, and a second second-type MOS device. The first first-type MOS device has a first terminal coupled to a first node, a second terminal coupled to a first voltage supply terminal, and a control terminal coupled to the first node. The second first-type MOS device has a first terminal coupled to a second node, a second terminal coupled to a third node, and a control terminal coupled to the first node. The first resistive element is coupled between the third node and the first voltage supply terminal. The first second-type MOS device has a first terminal coupled to a second voltage supply terminal, a second terminal coupled to the first node, a control terminal coupled to the second node. The second second-type MOS device has a first terminal coupled to the second voltage supply terminal, a second terminal coupled to the second node, a control terminal coupled to the second node. A first threshold voltage of the first first-type MOS device is greater than a second threshold voltage of the second first-type MOS device. Difference between a first slope representing variation of the first threshold voltage over temperature and a second slope representing variation of the second threshold voltage over temperature is substantially constant. A first reference voltage is generated from the third node.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows one exemplary embodiment of a reference circuit;

FIG. 2 is a schematic diagram showing variations of threshold voltages over temperature according to an exemplary embodiment;

FIG. 3A shows another exemplary embodiment of a reference circuit;

FIG. 3B shows another exemplary embodiment of a reference circuit;

FIG. 3C shows another exemplary embodiment of a reference circuit;

FIG. 4 shows another exemplary embodiment of a reference circuit;

FIG. 5 shows another exemplary embodiment of a reference circuit;

FIG. 6 shows another exemplary embodiment of a reference circuit;

FIG. 7 shows another exemplary embodiment of a reference circuit;

FIG. 8 shows another exemplary embodiment of a reference circuit;

FIG. 9A shows another exemplary embodiment of a reference circuit;

FIG. 9B shows another exemplary embodiment of a reference circuit; and

FIG. 9C shows another exemplary embodiment of a reference circuit.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

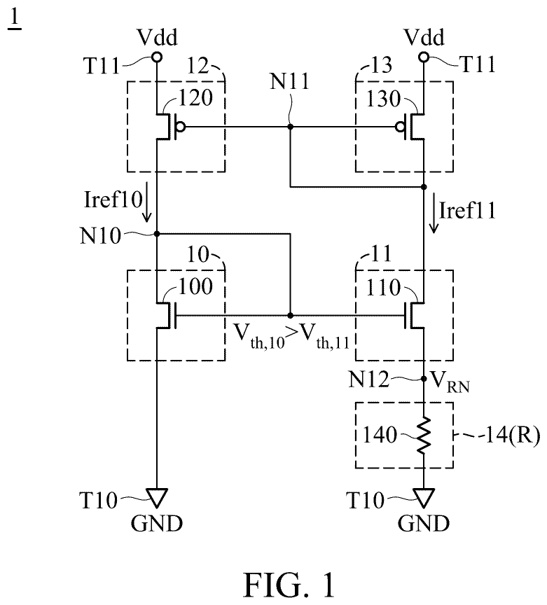

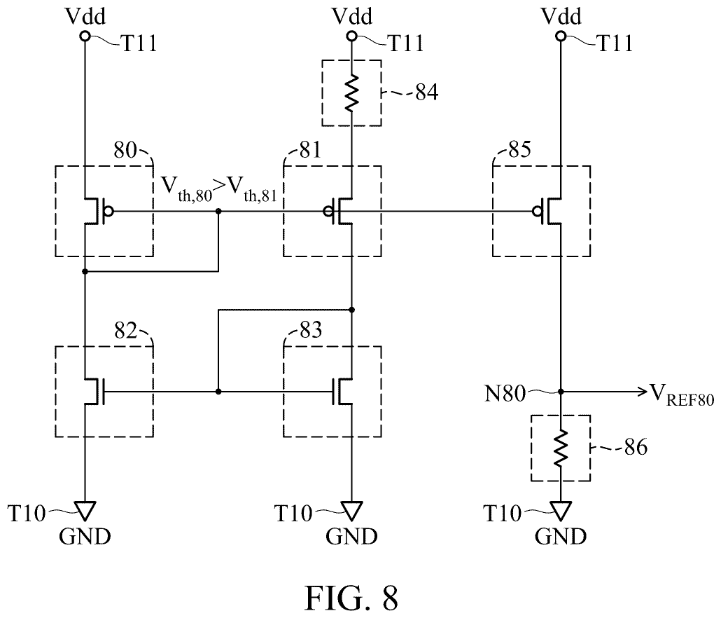

A reference circuit (such as, bandgap reference voltage generator) is typically used to analog circuit, wherein the reference circuit can be configured to generate a reference voltage or current. FIG. 1 shows one exemplary embodiment of a reference circuit 1. Referring to FIG. 1, the reference circuit 1 comprises first-type metal-oxide-semiconductor (MOS) devices 10 and 11, second-type MOS devices 12 and 13, and a resistive element 14. In the embodiment of FIG. 1, the term “first-type” indicates “N-type” for MOS devices, and the term “second-type” indicates “P-type” for MOS devices. In another embodiment (as shown by FIG. 8), the term “first-type” may indicate “P-type” for MOS devices, and the term “second-type” may indicate “N-type” for MOS devices. For ease of explanation and understanding, the present disclosure takes the first-type being N-type and the second-type being P-type as an example for illustration, but the present disclosure is not limited to this example. It should be noted that a person of ordinary skill in the art can easily know a variant embodiment in which the first-type is P-type and the second type is N-type. Therefore, the present disclosure does not describe the variant embodiment in detail. In the embodiment, the first-type MOS (such as NMOS) devices 10 and 11 are manufactured in an advanced process, and the threshold voltage (V_{th,10}) of the first-type MOS (such as NMOS) device 10 is greater than the threshold voltage (V_{th,11}) of the first-type MOS (such as NMOS) device 11. Generally, in the advanced process, multiple (such as four) different types of threshold voltages are provided for MOS devices of different types, including a standard threshold voltage, a low threshold voltage, an ultra-low threshold voltage, and an extreme-low threshold voltage. For example, the first-type MOS (such as NMOS) device 10 has a low threshold voltage, and the first-type MOS (such as NMOS) device 11 has an ultra-low threshold voltage.

As shown in FIG. 1, a first terminal of the first-type MOS (such as NMOS) device 10 is coupled to a node N10, a second terminal thereof is coupled to a voltage supply terminal T10, and a control terminal thereof is coupled to the node N10. A first terminal of the first-type MOS (such as NMOS) device 11 is coupled to a node N11, a second terminal thereof is coupled to a node N12, and a control terminal thereof coupled to the node N10. The resistive element 14 is coupled between the node N12 and the voltage supply terminal T10.

In the embodiment, the first-type MOS (such as NMOS) device 10 comprises a first-type MOS (such as NMOS) transistor 100. A drain, a source, and a gate of the first-type MOS (such as NMOS) transistor 100 are coupled to the first terminal, the second terminal, and the control terminal of the first-type MOS (such as NMOS) device 10 respectively. The first-type MOS (such as NMOS) device 11 comprises a first-type MOS (such as NMOS) transistor 110. A drain, a source, and a gate of the first-type MOS (such as NMOS) transistor 110 are coupled to the first terminal, the second terminal, and the control terminal of the first-type MOS (such as NMOS) device 11 respectively.

The resistive element 14 comprises a resistor 140. The resistor 140 is coupled between the node N12 and the voltage supply terminal T10.

A first terminal of the second-type MOS (such as PMOS) device 12 is coupled to a voltage supply terminal T11, a second terminal thereof is coupled to the node N10, a control terminal thereof is coupled to the node N11. A first terminal of the second-type MOS (such as PMOS) device 13 is coupled to the voltage supply terminal T11, a second terminal thereof is coupled to the node N11, a control terminal thereof is coupled to the node N11.

In the embodiment, the second-type MOS (such as PMOS) device 12 comprises a second-type MOS (such as PMOS) transistor 120. A source, a drain, and a gate of the second-type MOS (such as PMOS) transistor 120 are coupled to the first terminal, the second terminal, and the control terminal of the second-type MOS (such as PMOS) device 12 respectively. The second-type MOS (such as PMOS) device 13 comprises a second-type MOS (such as PMOS) transistor 130. A source, a drain, and a gate of the second-type MOS (such as PMOS) transistor 130 are coupled to the first terminal, the second terminal, and the control terminal of the second-type MOS (such as PMOS) device 13 respectively.

In the embodiment of FIG. 1, when an operating voltage Vdd is provided to the voltage supply terminal T11 and the voltage supply terminal T10 is coupled to a ground GND, the reference circuit 1 operates to generate a reference current Iref10 flowing the first-type MOS (such as NMOS) device 10 and further generate a reference current Iref11 flowing the first-type MOS (such as NMOS) device 11. In the embodiment, the second-type MOS (such as PMOS) devices 12 and 13 can be regarded as a current source. A reference voltage V_{RN} is generated at the node N12 according to the reference current Iref11 and the resistance value R of the resistive element 14. According to the embodiment, the reference current Iref11 and the reference voltage V_{RN} are almost insensitive to the temperature, in other words, the temperature has low effect on the reference current Iref11 and the reference voltage V_{RN}, which is explained in the following paragraphs.

In one embodiment, the size of the first-type MOS (such as NMOS) device 10 is substantially equal to the size of the first-type MOS (such as NMOS) device 11, in other words, the ratio of the size of the first-type MOS (such as NMOS) device 10 to the size of the first-type MOS (such as NMOS) device 11 is substantially equal to 1. To simplify the explanation, the following embodiment takes the ratio as 1 as an example, however, the present disclosure is not limited to this. The size of the first-type MOS (such as NMOS) device 10 is represented by

$$\frac{{W}_{10}}{{L}_{10}} ,$$

and the size of the first-type MOS (such as NMOS) device 11 is represented by

$$\frac{{W}_{11}}{{L}_{11}} ,$$

wherein W₁₀ and L₁₀ represent the width and length of the equivalent channel of the first-type MOS (such as NMOS) device 10, and W₁₁ and L₁₁ represent the width and length of the equivalent channel of the first-type MOS (such as NMOS) device 11.

### Saturation Region

In a case where the first-type MOS (such as NMOS) devices 10 and 11 operate in the saturation region, the reference current Iref10 is equal to the reference current Iref11, Equation (1) is obtained as:

$${i}_{R E F} = \frac{1}{2} {μ}_{n} \cdot {C}_{o x} \cdot \frac{{W}_{10}}{{L}_{10}} \cdot {( {V}_{g s , 10} - {V}_{t h , 10} )}^{2} = \frac{1}{2} {μ}_{n} \cdot {C}_{o x} \cdot \frac{{W}_{11}}{{L}_{11}} \cdot {( {V}_{g s , 11} - {V}_{t h , 11} )}^{2} \qquad Equation ( 1 )$$

The i_{REF} represents the values of the reference currents Iref10 and Iref11. μₙ represents the mobility of electrons. Cox represents the gate oxide capacitance per unit area. V_{gs,10} represents the gate-source voltage of the first-type MOS (such as NMOS) device 10. V_{gs,11} represents the gate-source voltage of the first-type MOS (such as NMOS) device 11. V_{th,10} represents the threshold voltage of the first-type MOS (such as NMOS) device 10. V_{th,11} represents the threshold voltage of the first-type MOS (such as NMOS) device 11.

Based on Equation (1), the gate-source voltage V_{gs,10} of the first-type MOS (such as NMOS) device 10 is obtained as Equation (2):

$${V}_{gs , 10} = {V}_{t h , 10} + \sqrt{\frac{2 {i}_{R E F}}{{μ}_{n} \cdot {C}_{o x}} \times \frac{{L}_{10}}{{W}_{10}}} \qquad Equation ( 2 )$$

Based on Equation (1), the gate-source voltage V_{gs,11} of the first-type MOS (such as NMOS) device 11 is obtained as Equation (3):

$${V}_{g s , 11} = {V}_{t h , 11} + \sqrt{\frac{2 {i}_{R E F}}{{μ}_{n} \cdot {C}_{o x}} \times \frac{{L}_{11}}{{W}_{11}}} \qquad Equation ( 3 )$$

Referring to FIG. 1, the relationship between the gate-source voltages V_{gs,10} and V_{gs,11} is shown in Equation (4):

$${V}_{g s , 10} = {V}_{g s , 11} + {i}_{R E F} \cdot R \qquad Equation ( 4 )$$

Equation (4) is re-written as Equation (5) according to Equation (2) and Equation (3):

$${V}_{t h , 10} + \sqrt{\frac{2 {i}_{R E F}}{{μ}_{n} \cdot {C}_{o x}} \times \frac{{L}_{10}}{{W}_{10}}} = {V}_{t h , 11} + \sqrt{\frac{2 {i}_{R E F}}{{μ}_{n} \cdot {C}_{o x}} \times \frac{{L}_{11}}{{W}_{11}}} + {i}_{R E F} \cdot R \qquad Equation ( 5 )$$

As described above, the reference voltage V_{RN} is generated at the node N12 according to the reference current Iref11 and the resistance value R of the resistive element 14, and the values of the reference currents Iref10 and Iref11 are represented by i_{REF}. Thus, the term i_{REF}. R represents the reference voltage V_{RN}. Assume

$$K = \frac{{W}_{11}}{{L}_{11}} / \frac{{W}_{10}}{{L}_{10}} ,$$

then Equation (6) is obtained according to Equation (5) as:

$${V}_{R N} = {( \sqrt{{V}_{th , 10} - {V}_{th , 11} + \frac{1}{2 {μ}_{n} \cdot {C}_{o x} \cdot R} \times \frac{{L}_{11}}{{W}_{11}} \cdot {( K - 1 )}^{2}} + \sqrt{\frac{1}{2 {μ}_{n} \cdot {C}_{o x} \cdot R} \times \frac{{L}_{11}}{{W}_{11}}} \cdot ( K - 1 ) )}^{2} \qquad Equation ( 6 )$$

When

$$\frac{{W}_{10}}{{L}_{10}} = \frac{{W}_{11}}{{L}_{11}} ( i . e . , K = 1 ) ,$$

Equation (1) is obtained according to Equation (6) as:

$${V}_{R N} = {V}_{th , 10} - {V}_{t h , 11} = {Δ V}_{t h} \qquad Equation ( 7 )$$

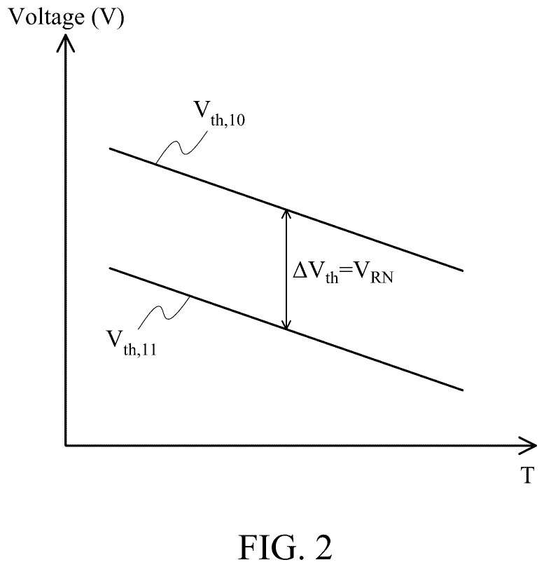

In the embodiment, the threshold voltages V_{th,10} and V_{th,11} of the first-type MOS (such as NMOS) devices 10 and 11 are complementary to absolute temperature (CTAT). In the disclosure, the difference between a first slope representing variation of the first threshold voltage V_{th,10} over temperature and a second slope representing variation of the second threshold voltage V_{th,11} over temperature is substantially constant. Specifically, the first slope is equal (substantially) to the second slope or the difference is close to 0 or within a predetermined range near 0. Referring to FIG. 2, the variation of the threshold voltage V_{th,10} over the temperature is close to or equal to the variation of the threshold voltage V_{th,11} over the temperature. Thus,

$$\frac{\partial {ΔV}_{th}}{\partial T} ≅ 0 ,$$

that is,

$$\frac{\partial {V}_{RN}}{\partial T} ≅ 0 .$$

In other words, as shown in the FIG. 2, the difference between the slope representing variation of the threshold voltage V_{th,10} over temperature and the slope representing variation of the threshold voltage V_{th,11} over temperature is within a predetermined range of 0 (i.e., the difference is approximately equal to 0). Accordingly, the reference voltage V_{RN} obtained by Equation (7) is almost insensitive to the temperature.

Since the reference voltage V_{RN} is insensitive to the temperature in the saturation region, the reference current Iref11 (i_{REF}) related to the reference voltage V_{RN} is also insensitive to the temperature. Thus, the reference circuit 1 provides the reference current Iref11 and the reference V_{RN} which are insensitive to the temperature in the saturation region.

### Sub-Threshold Region

In a case where the first-type MOS (such as NMOS) devices 10 and 11 operate in the sub-threshold region, the reference current Iref10 is equal to the reference current Iref11, Equation (8) is obtained as:

$${i}_{REF} = {I}_{D 0} \cdot \frac{{W}_{10}}{{L}_{10}} \cdot {e}^{( \frac{{V}_{gs , 10} - {V}_{th , 10}}{n \cdot {V}_{T}} )} = {I}_{D 0} \cdot \frac{{W}_{11}}{{L}_{11}} \cdot {e}^{( \frac{{V}_{gs , 11} - {V}_{th , 11}}{n \cdot {V}_{T}} )} \qquad Equation ( 8 )$$

n·V_{T} is equal to

$$\frac{n \cdot k \cdot T}{q} ( n \cdot {V}_{T} = \frac{n \cdot k \cdot T}{q} ) ,$$

wherein n represents the swing coefficient, k represents the Boltzmann constant, T represents the temperature, q represents the electrical charge. I_{D0} is equal to

$${μ}_{n} \cdot {C}_{ox} \cdot ( n - 1 ) \cdot {V}_{T}^{2} ( {I}_{D 0} = {μ}_{n} \cdot {C}_{ox} \cdot ( n - 1 ) \cdot {V}_{T}^{2} ) .$$

Based on Equation (8), the gate-source voltage V_{gs,10} of the first-type MOS (such as NMOS) device 10 is obtained as Equation (9):

$${V}_{gs , 10} = {V}_{th , 10} + n \cdot {V}_{T} \cdot ln ( \frac{{L}_{10}}{{W}_{10}} \cdot \frac{{i}_{REF}}{{I}_{D 0}} ) \qquad Equation ( 9 )$$

Based on Equation (8), the gate-source voltage V_{gs,11} of the first-type MOS (such as NMOS) device 11 is obtained as Equation (10):

$${V}_{gs , 11} = {V}_{th , 11} + n \cdot {V}_{T} \cdot ln ( \frac{{L}_{11}}{{W}_{11}} \cdot \frac{{i}_{REF}}{{I}_{D 0}} ) \qquad Equation ( 10 )$$

Referring to FIG. 1, the relationship between the gate-source voltages V_{gs,10} and V_{gs,11} is shown in the above Equation (4):

$${V}_{gs , 10} = {V}_{gs , 11} + {i}_{REF} \cdot R \qquad Equation ( 4 )$$

Equation (4) is re-written as Equation (11) according to Equation (9) and Equation (10):

$${V}_{th , 10} + n \cdot {V}_{T} \cdot ln ( \frac{{L}_{10}}{{W}_{10}} \cdot \frac{{i}_{REF}}{{I}_{D 0}} ) = {V}_{th , 11} + n \cdot {V}_{T} \cdot ln ( \frac{{L}_{11}}{{W}_{11}} \cdot \frac{{i}_{REF}}{{I}_{D 0}} ) + {i}_{REF} \cdot R \qquad Equation ( 11 )$$

Assume

$$K = \frac{{W}_{11}}{{L}_{11}} / \frac{{W}_{10}}{{L}_{10}} ,$$

Equation (12) is obtained according to Equation (11) as:

$${V}_{RN} = {V}_{th , 10} - {V}_{th , 11} + n \cdot {V}_{T} \cdot ln ( K ) \qquad Equation ( 12 )$$

When

$$\frac{{W}_{10}}{{L}_{10}} = \frac{{W}_{11}}{{L}_{11}} ( i . e . , K = 1 ) ,$$

Equation (13) is obtained according to Equation (12) as:

$${V}_{RN} = {V}_{th , 10} - {V}_{th , 11} = {Δ V}_{th} \qquad Equation ( 13 )$$

In the disclosure, the difference between a first slope representing variation of the first threshold voltage V_{th,10} over temperature and a second slope representing variation of the second threshold voltage V_{th,11} over temperature is nearly constant. Specifically, in the embodiment, the variation of the threshold voltage V_{th,10} over the temperature is close to or equal to the variation of the threshold voltage V_{th,11} over the temperature, as shown in FIG. 2. Thus,

$$\frac{\partial {Δ V}_{th}}{\partial T} ≅ 0 ,$$

that is,

$$\frac{\partial {V}_{RN}}{\partial T} ≅ 0 .$$

In other words, the difference between the slope representing variation of the threshold voltage V_{th,10} over temperature and the slope representing variation of the threshold voltage V_{th,11} over temperature is equal to 0 or within a predetermined range of 0 (i.e., the difference is approximately equal to 0). Accordingly, the reference voltage V_{RN} obtained by Equation (13) is insensitive to the temperature.

Since the reference voltage V_{RN} is insensitive to the temperature in the sub-threshold region, the reference current Iref11 (i_{REF}) related to the reference V_{RN} is also insensitive to the temperature. Thus, the reference circuit 1 provides the reference current Iref11 and the reference V_{RN} which are insensitive to the temperature in the sub-threshold region.

According to the embodiment of FIG. 1, when the first-type MOS (such as NMOS) devices 10 and 11 operate normally (that is, the first-type MOS (such as NMOS) devices 10 and 11 operate in the saturation region and the sub-threshold region), the reference current Iref11 and the reference V_{RN} are almost insensitive to the temperature.

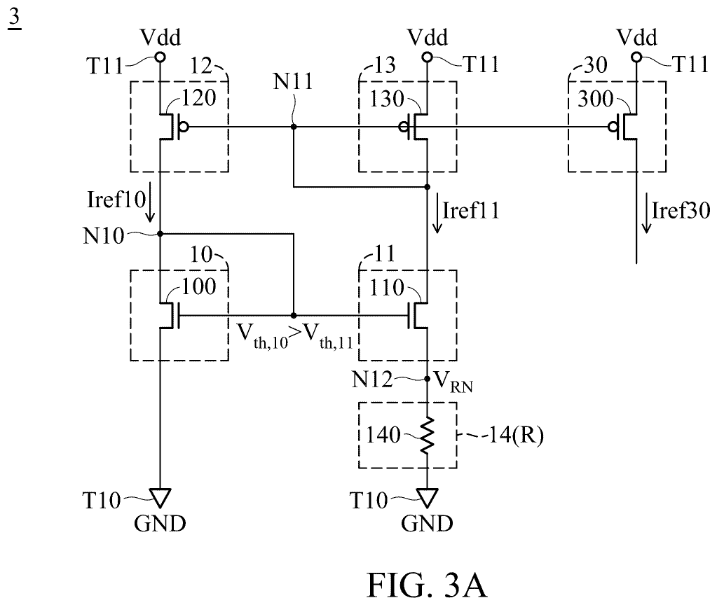

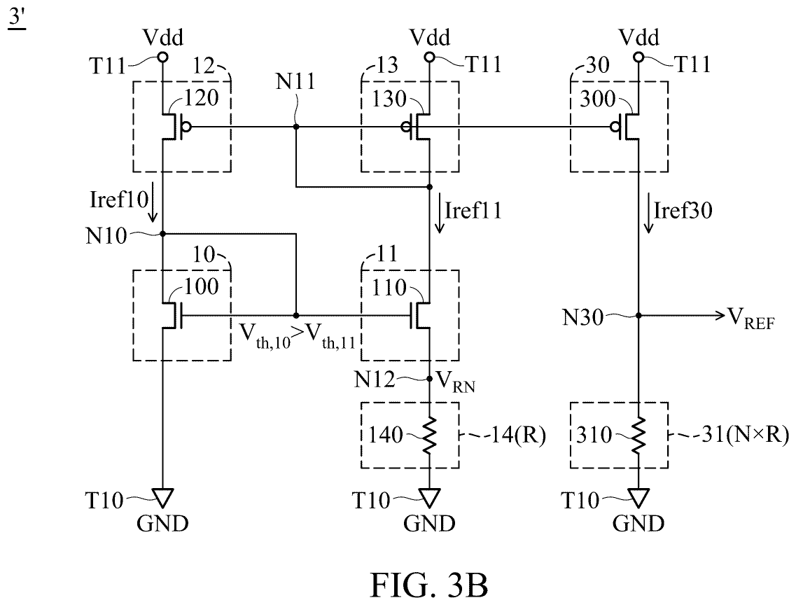

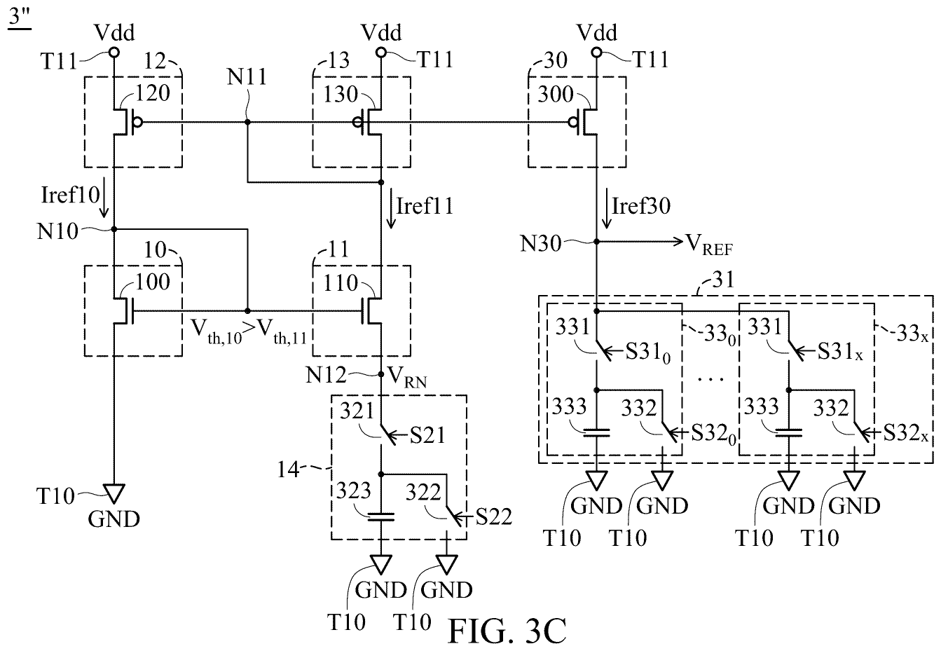

FIG. 3A shows another exemplary embodiment of a reference circuit. Referring to FIG. 3A, a reference circuit 3 comprises the first-type MOS (such as NMOS) devices 10 and 11, the second-type MOS (such as PMOS) devices 12 and 13, and the resistive element 14 of the reference circuit 1 in FIG. 1 and further comprises third second-type MOS (such as PMOS) device 30.

The circuit structures and operations of the first-type MOS (such as NMOS) devices 10 and 11, the second-type MOS (such as PMOS) devices 12 and 13, and the resistive element 14 are provided as those in the embodiment of FIG. 1. Thus, the related description is omitted.

A first terminal of the third second-type MOS (such as PMOS) device 30 is coupled to the voltage supply terminal T11, a second terminal thereof is configured to generate a reference current Iref30, and a control terminal thereof is coupled to the node N11. In the embodiment, the third second-type MOS (such as PMOS) device 30 comprises a second-type MOS (such as PMOS) transistor 300. A source, a drain, and a gate of the second-type MOS (such as PMOS) transistor 300 are coupled to the first terminal, the second terminal, and the control terminal of the third second-type MOS (such as PMOS) device 30 respectively.

In FIG. 3A, the number of third second-type MOS (such as PMOS) device 30 being one is one exemplary embodiment, but the disclosure is not limited thereto. In some embodiments, the number of third second-type MOS (such as PMOS) device 30 may be two or more than two, which may provide a plurality of reference currents. The arrangement and the internal component of the two or more than two third second-type MOS (such as PMOS) devices are the same as or similar to the arrangement and the internal component of third second-type MOS (such as PMOS) device 30. Thus, the related description is omitted.

FIG. 3B shows another exemplary embodiment of a reference circuit. Referring to FIG. 3B, a reference circuit 3′ comprises the first-type MOS (such as NMOS) devices 10 and 11, the second-type MOS (such as PMOS) devices 12 and 13, and the resistive element 14 of the reference circuit 1 in FIG. 1 and further comprises third second-type MOS (such as PMOS) device 30 and a resistive element 31.

The circuit structures and operations of the first-type MOS (such as NMOS) devices 10 and 11, the second-type MOS (such as PMOS) devices 12 and 13, and the resistive element 14 are provided as those in the embodiment of FIG. 1. Thus, the related description is omitted.

A first terminal of the third second-type MOS (such as PMOS) device 30 is coupled to the voltage supply terminal T11, a second terminal thereof is coupled to the node N30, a control terminal thereof is coupled to the node N11. In the embodiment, the third second-type MOS (such as PMOS) device 30 comprises a second-type MOS (such as PMOS) transistor 300. A source, a drain, and a gate of the second-type MOS (such as PMOS) transistor 300 are coupled to the first terminal, the second terminal, and the control terminal of the third second-type MOS (such as PMOS) device 30 respectively.

The resistive element 31 comprises a resistor 310. The resistor 310 is coupled between the node N30 and the voltage supply terminal T10. The resistance value (N×R) of the resistive element 31 is equal to N times the resistance value R of the resistive element 14.

In the embodiment of FIG. 3B, when an operating voltage Vdd is provided to the voltage supply terminal T11 and the voltage supply terminal T10 is coupled to the ground GND, the reference circuit 3′ operates to generate a reference current Iref10 flowing the first-type MOS (such as NMOS) device 10, generate a reference current Iref11 flowing the first-type MOS (such as NMOS) device 11, and further generate a reference current Iref30 flowing the resistive element 31. A reference voltage VREF is generated at the node N30 according to the reference current Iref30 and the resistance value (N×R) of the resistive element 31.

Referring to the PMOS devices 13 and 30 form a current mirror which generates reference current Iref30 according to the reference current Iref11, wherein the reference current Iref30 can be generated to be equal to the reference current Iref11 which may be equal to the reference current Iref10. Since The resistance value (N×R) of the resistive element 21 is equal to N times the resistance value R of the resistive element 14, the reference voltage VREF is equal to N times the reference voltage V_{RN}.

As described above, the reference current Iref11 and the reference V_{RN} are insensitive to the temperature. Thus, the reference voltage VREF is also insensitive to the temperature.

FIG. 3C shows another exemplary embodiment of a reference circuit. Referring to FIG. 3C, a reference circuit 3″ comprises the first-type MOS (such as NMOS) devices 10 and 11, the second-type MOS (such as PMOS) devices 12 and 13, and the third second-type MOS (such as PMOS) device 30 of the reference circuit 3′ in FIG. 3B and further comprises a resistive element 14, and a resistive element 31.

The circuit structures and operations of the first-type MOS (such as NMOS) devices 10 and 11, the second-type MOS (such as PMOS) devices 12 and 13, and the third second-type MOS (such as PMOS) device 30 are provided as those in the embodiment of FIG. 3B. Thus, the related description is omitted.

The resistive element 14 comprises a switch 321, a switch 322 and a capacitor 323. The switch 321 and the capacitor 323 are coupled in series between the node N12 and the voltage supply terminal T10, and the switch 322 is coupled in parallel with the capacitor 323, with one terminal of the switch 322 coupled to the voltage supply terminal T10. In details, a first terminal of the switch 321 is coupled to the node N12, a first terminal of the capacitor 323 is coupled to a second terminal of the switch 321, a second terminal of the capacitor 323 is coupled to the voltage supply terminal T10, a first terminal of the switch 322 is coupled to the second terminal of the switch 321, and a second terminal of the switch 322 is coupled to the voltage supply terminal T10. Through the switching signals S21 and S22, the switches 321 and 322 are controlled to be turned on or off.

The resistive element 31 comprises a plurality of pairs 33₀-33_{X} of two switches 331 and 332 and one capacitor 333. The plurality pairs 33₀-33_{X} of two switches 331 and 332 and one capacitor 333 are coupled in parallel between the node N30 and the power supply terminal T10. For each pair 33₀-33_{X} of two switches 331 and 332 and one capacitor 333, the switch 331 and the capacitor 333 are coupled in series between the node N30 and the voltage supply terminal T10, and the switch 332 is coupled in parallel with the capacitor 333, with one terminal of the switch 332 coupled to the voltage supply terminal T10. In details, a first terminal of the switch 331 is coupled to the node N30, a first terminal of the capacitor 333 is coupled to a second terminal of the switch 331, a second terminal of the capacitor 333 is coupled to the voltage supply terminal T10, a first terminal of the switch 332 is coupled to the second terminal of the switch 331, and a second terminal of the switch 332 is coupled to the voltage supply terminal T10. Through the switching signals S31₀-S31_{X}, each of the switches 331 is controlled to be turned on or off. Through the switching signals S32₀-S32_{X}, each of the switches 332 is controlled to be turned on or off.

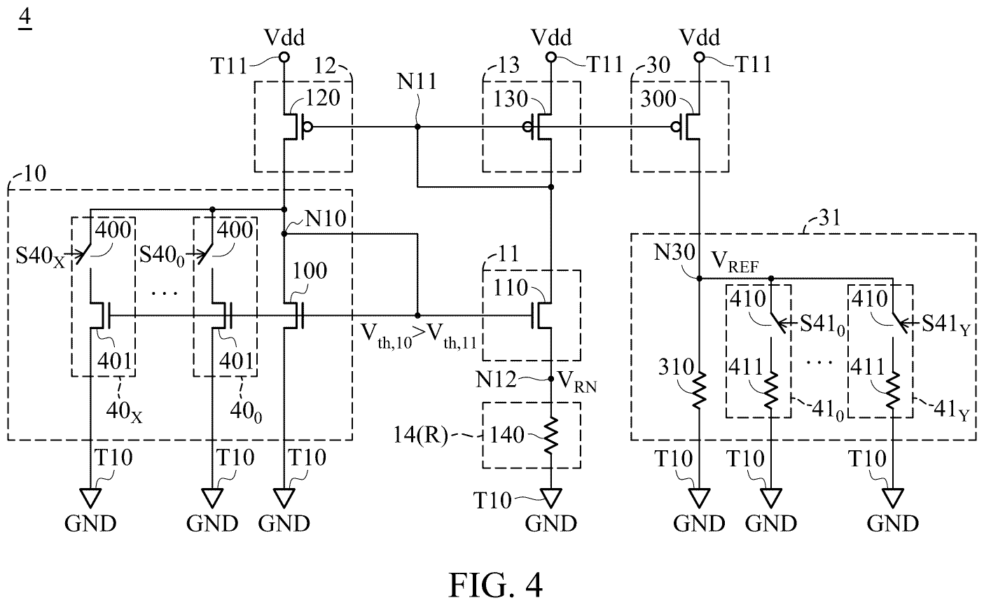

In order to provide an accurate reference voltage, the reference circuit 3′ further apply trimming mechanism. Referring to FIG. 4, a reference circuit 4 is a variation of the reference circuit 3′. In the reference circuit 4, the first-type MOS (such as NMOS) device 10 comprises the first-type MOS (such as MOS) transistor 100 and further comprises a plurality pairs 40₀-40_{X} of one switch and one first-type MOS (such as NMOS) transistor for trimming the reference voltage VREF.

As shown in FIG. 4, the first-type MOS (such as NMOS) device 10 comprises a plurality of pairs 40₀-40_{X} of one switch 400 and one first-type MOS (such as MOS) transistor 401. The plurality pairs 40₀-40_{X} of one switch 400 and one first-type MOS transistor 401 are coupled in parallel between the node N10 and the power supply terminal T10, and the first-type MOS (such as NMOS) transistor 401 has a gate coupled to the gate of the first-type MOS (such as NMOS) transistor 100. For each pair 40₀-40_{X} of one switch 400 and one first-type MOS (such as NMOS) transistor 401, the switch 400 and the first-type MOS (such as NMOS) transistor 401 are coupled in series between the node N10 and the power supply terminal T10. In details, in some embodiments, a first terminal of the switch 400 is coupled to the node N10, a drain of the first-type MOS (such as NMOS) transistor 401 is coupled to a second terminal of the switch 400, a source of the first-type MOS (such as NMOS) transistor 401 is coupled to the voltage supply terminal T10, and the gate of the first-type MOS (such as NMOS) transistor 401 is coupled to the gate of the first-type MOS (such as NMOS) transistor 100. In some embodiments, a drain of the first-type MOS (such as NMOS) transistor 401 is coupled to the node N10, the gate of the first-type MOS (such as NMOS) transistor 401 is coupled to the gate of the first-type MOS (such as NMOS) transistor 100, a first terminal of the switch 400 is coupled to a source of the first-type MOS (such as NMOS) transistor 401, and a second terminal of the switch 400 is coupled to the voltage supply terminal T10. Through the switching signals S40₀-S40_{X}, each of the switches 400 is controlled to be turned on or off. When one switch 400 is turned on, the corresponding first-type MOS (such as NMOS transistor) 401 is coupled in parallel with the first-type MOS (such as NMOS transistor) 100. In the embodiment, the slope representing variation of the threshold voltage V_{th,10} over temperature can be determined or trimmed according to the size of the first-type MOS (such as NMOS) transistor 100 and the size of the first-type MOS (such as NMOS) transistor(s) 401 coupled to the turned-on switch(es) 400.

In a case where there is difference between the slope representing variation of the threshold voltage V_{th,10} over temperature and the slope representing variation of the threshold voltage V_{th,11} over temperature due to mismatching between the first-type MOS (such as NMOS) transistors 100 and 110 induced by variation in the process, the difference between the two slopes can be decreased or eliminated through paralleling at least one first-type MOS (such as NMOS) transistors 401 with the first-type MOS (such as NMOS transistor) 100.

As shown in FIG. 4, the resistive element 31 comprises a plurality of pairs 41₀-41_{Y} of one switch 410 and one resistor 411. The plurality of pairs 41₀-41_{Y} of one switch 410 and one second resistor 411 are coupled in parallel between the node N30 and the voltage supply terminal T10. For each pair 41₀-41_{Y} of one switch 410 and one resistor 411, the switch 410 and the resistor 411 are coupled in series between the node N30 and the power supply terminal T10. In details, in some embodiments, a first terminal of the switch 410 is coupled to the node N30, and the resistor 411 is coupled between a second terminal of the switch 410 and the voltage supply terminal T10. In some embodiments, a first terminal of the resistor 411 is coupled to the node N30, and the switch 410 is coupled between a second terminal of the resistor 411 and the voltage supply terminal T10. Through the switching signals S41₀-S41_{Y}, each of the switches 410 is controlled to be turned on or off. When one switch 410 is turned on, the corresponding resistor 411 is coupled in parallel with the resistor 410. In the embodiment, the resistance value of the resistive element 31 is determined according to the resistance value of the resistor 310 and the total resistance value of the resistor(s) 411 coupled to the turned-on switch(es) 410. Thus, the resistance value of the resistive element 31 can be trimmed through paralleling at least one resistor 411 with the resistor 310. According to the trimming for the resistive element 31, the total resistance value of the resistive element 31 can be determined such that the reference Vref is within a predetermined voltage within in a predetermined temperature range. For example, the predetermined voltage range includes a target voltage, such as 550 mV, and the predetermined temperature range includes a target temperature, such as 40 degrees.

In the embodiment of FIG. 4, the reference circuit 4 applies trimming mechanism to the first-type MOS (such as NMOS) device 10 and the resistive element 31. In another embodiment, the reference circuit 4 applies trimming mechanism only to the first-type MOS (such as NMOS) device 10, that is, the resistive element 31 does not comprise pairs 41₀-41_{Y} of one switch 410 and one resistor 411. In another embodiment, the reference circuit 4 applies trimming mechanism only to the resistive element 31, that is, the first-type MOS (such as NMOS) device 10 does not comprise the pairs 40₀-40_{X} of one switch 400 and one first-type MOS (such as NMOS transistor) 401.

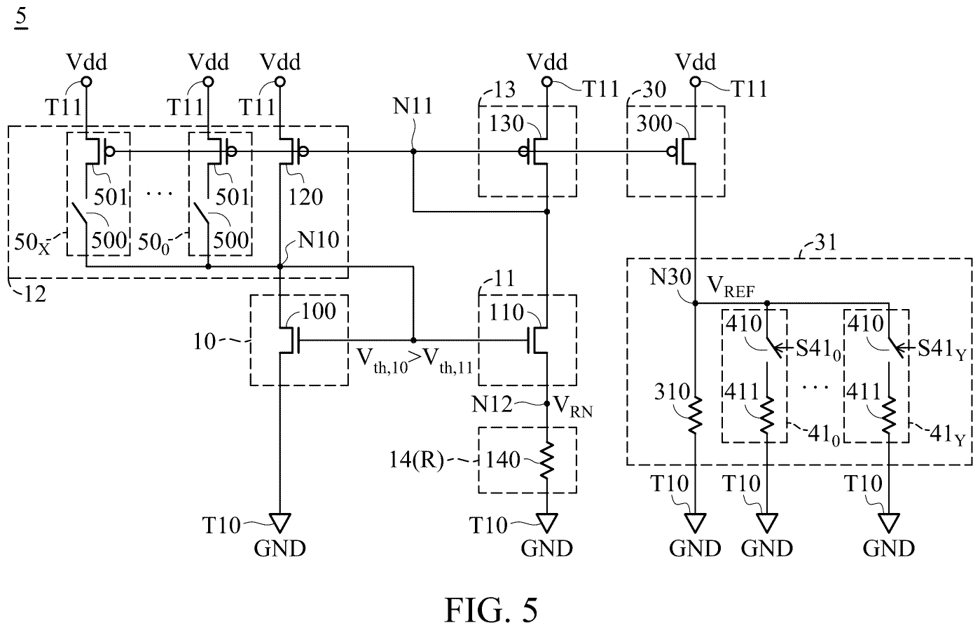

In another embodiment, the reference circuit 3′ applies trimming mechanism to the second-type MOS (such as PMOS) device 12. As shown in FIG. 5, a reference circuit 5 is a variation of the reference circuit 3′. In the reference circuit 5, the second-type MOS (such as PMOS) device 12 further comprises a plurality of pairs 50₀-50_{X} of one switch 500 and one second-type MOS (such as PMOS) transistor 501. The plurality of pairs 50₀-50_{X} of one switch 500 and one second-type MOS (such as PMOS) transistor 501 are coupled in parallel between the power supply terminal T11 and the node N10. For each pair 50₀-50_{X} of one switch 500 and one second-type MOS (such as PMOS) transistor 501, the second-type MOS (such as PMOS) transistor 501 and the switch 500 are coupled in series between the power supply terminal T11 and the node N10. In details, in some embodiments, a source of the second-type MOS (such as PMOS) transistor 501 is coupled to the power supply terminal T11, the gate of the second-type MOS (such as PMOS) transistor 501 is coupled to the gate of the second-type MOS (such as PMOS) transistor 120, a first terminal of the switch 500 is coupled to a drain of the second-type MOS (such as PMOS) transistor 501, and a second terminal of the switch 500 is coupled to the node N10. In some embodiments, a first terminal of the switch 500 is coupled to the power supply terminal T11, a source of the second-type MOS (such as PMOS) transistor 501 is coupled to a second terminal of the switch 500, a drain of the second-type MOS (such as PMOS) transistor 501 is coupled to the node N10, and the gate of the second-type MOS (such as PMOS) transistor 501 is coupled to the gate of the second-type MOS (such as PMOS) transistor 120. In the embodiment, the slope representing variation of the threshold voltage V_{th,10} over temperature is determined or trimmed by controlling at least one switch 500 to be turned on or off.

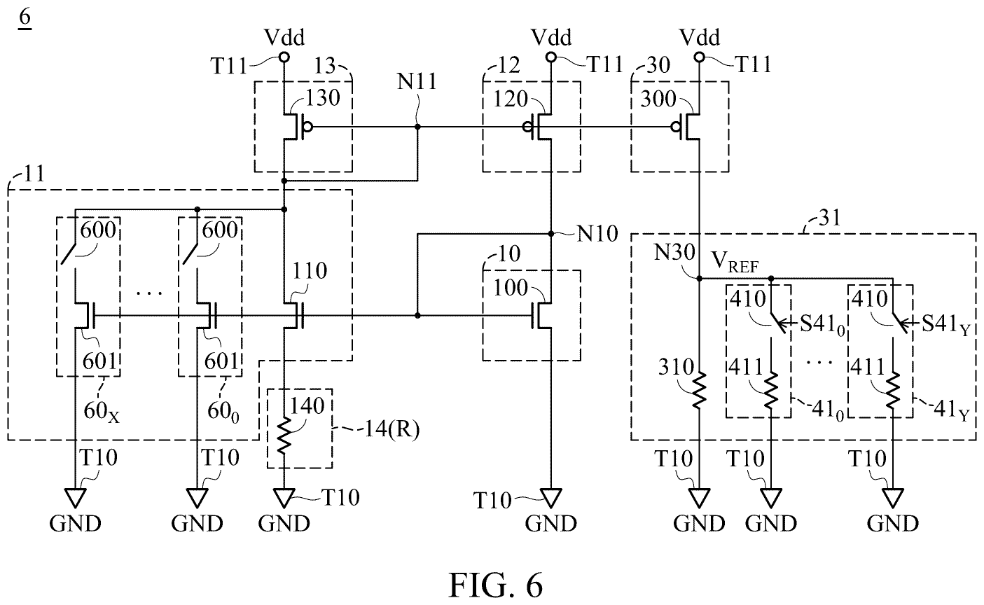

In another embodiment, the reference circuit 3′ applies trimming mechanism to the first-type MOS (such as NMOS) device 11. As shown in FIG. 6, a reference circuit 6 is a variation of the reference circuit 3′. In the reference circuit 6, the first-type MOS (such as NMOS) device 11 further comprises a plurality of pairs 60₀-60_{X} of one switch 60₀ and one first-type MOS (such as NMOS) transistor 601. The plurality of pairs 60₀-60_{X} of one switch 600 and one first-type MOS (such as NMOS) transistor 601 are coupled in parallel between the node N11 and the voltage supply terminal T10. For each pair 60₀-60_{X} of one switch 600 and one first-type MOS (such as NMOS) transistor 601, the switch 600 and the first-type MOS (such as NMOS) transistor 601 are coupled in series between the node N11 and the power supply terminal T10. In details, in some embodiments, a first terminal of the switch 600 is coupled to the node N11, a drain of the first-type MOS (such as NMOS) transistor 601 is coupled to a second terminal of the switch 600, a source of the first-type MOS (such as NMOS) transistor 601 is coupled to the voltage supply terminal T10, and the gate of the first-type MOS (such as NMOS) transistor 601 is coupled to the gate of the first-type MOS (such as NMOS) transistor 110. In some embodiments, a drain of the first-type MOS (such as NMOS) transistor 601 is coupled to the node N11, the gate of the first-type MOS (such as NMOS) transistor 601 is coupled to the gate of the first-type MOS (such as NMOS) transistor 110, a first terminal of the switch 600 is coupled to a source of the first-type MOS (such as NMOS) transistor 601, and a second terminal of the switch 600 is coupled to the voltage supply terminal T10. In the embodiment, the slope representing variation of the threshold voltage V_{th,11} over temperature is determined or trimmed by controlling at least one switch 600 to be turned on or off.

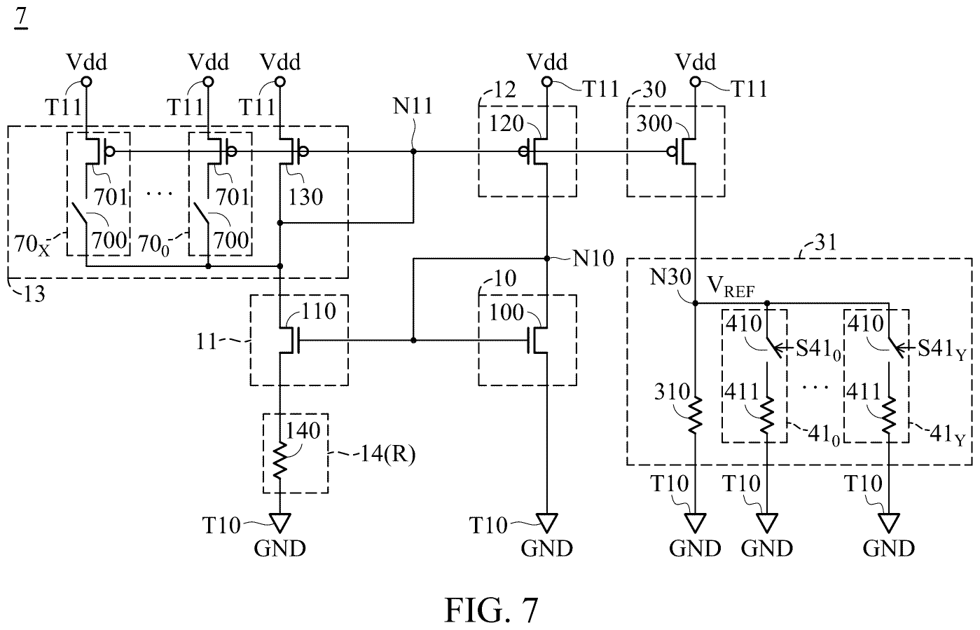

In another embodiment, the reference circuit 3′ applies trimming mechanism to the second-type MOS (such as PMOS) device 13. As shown in FIG. 7, a reference circuit 7 is a variation of the reference circuit 3′. In the reference circuit 7, the second-type MOS (such as PMOS) device 13 further comprises a plurality of pairs 70₀-70_{X} of one switch 700 and one second-type MOS (such as PMOS) transistor 701. The plurality of pairs 70₀-70_{X} of one switch 700 and one second-type MOS (such as PMOS) transistor 701 are coupled in parallel between the power supply terminal T11 and the node N11. For each pair 70₀-70_{X} of one switch 700 and one second-type MOS (such as PMOS) transistor 701, the second-type MOS (such as PMOS) transistor 701 and the switch 700 are coupled in series between the power supply terminal T11 and the node N11. In details, in some embodiments, a source of the second-type MOS (such as PMOS) transistor 701 is coupled to the power supply terminal T11, the gate of the second-type MOS (such as PMOS) transistor 701 is coupled to the gate of the second-type MOS (such as PMOS) transistor 130, a first terminal of the switch 700 is coupled to a drain of the second-type MOS (such as PMOS) transistor 701, and a second terminal of the switch 700 is coupled to the node N11. In some embodiments, a first terminal of the switch 700 is coupled to the power supply terminal T11, a source of the second-type MOS (such as PMOS) transistor 701 is coupled to a second terminal of the switch 700, a drain of the second-type MOS (such as PMOS) transistor 701 is coupled to the node N11, and the gate of the second-type MOS (such as PMOS) transistor 701 is coupled to the gate of the second-type MOS (such as PMOS) transistor 130. In the embodiment, the slope representing variation of the threshold voltage V_{th,11} over temperature is determined or trimmed by controlling at least one switch 700 to be turned on or off.

In the above embodiments, the reference circuits in FIG. 1 and FIG. 3A-7 are provided to cause the variation of the threshold voltage V_{th,10} of the first-type MOS (such as NMOS) device 10 over the temperature to be close to or equal to the variation of the threshold voltage V_{th,11} of the first-type MOS (such as NMOS) device 11 over the temperature. In another embodiment, a reference circuit 8 comprises first-type MOS (such as PMOS) devices 80, 81, and 85, second-type MOS (such as NMOS) devices 82 and 83, and resistive elements 84 and 86. The threshold voltage of the first-type MOS (such as PMOS) device 80 is greater than the threshold voltage of the first-type MOS (such as PMOS) device 81. The analysis of the reference circuit 8 is similar to the analysis of the reference circuit 3′, and the related description is omitted.

According to the embodiment of FIG. 8, the difference between the slope representing variation of the threshold voltage V_{th,80} of the first-type MOS (such as PMOS) device 80 over temperature and the slope representing variation of the threshold voltage V_{th,81} of the first-type MOS (such as PMOS) device 81 over temperature is equal to 0 or within a predetermined range of 0 (i.e., the difference is approximately equal to 0). Accordingly, the reference current flowing the resistive element 86 and the reference voltage V_{REF80} at the node N80 are insensitive to the temperature.

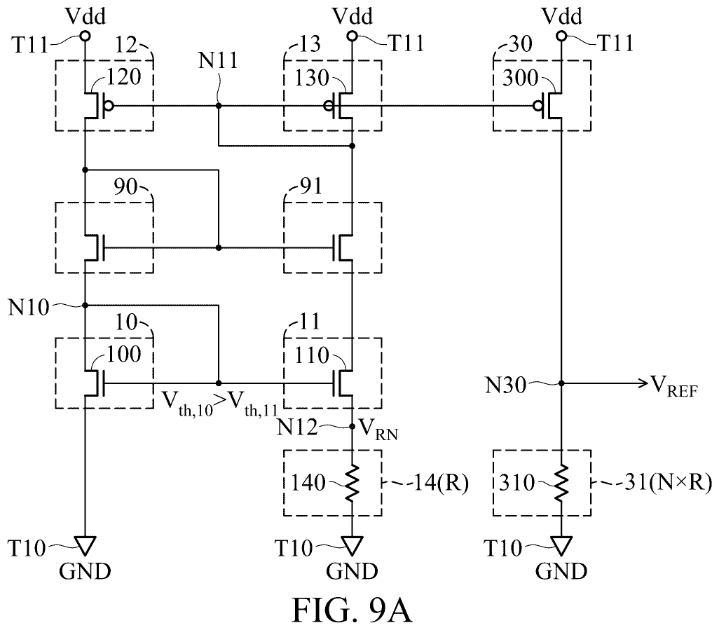

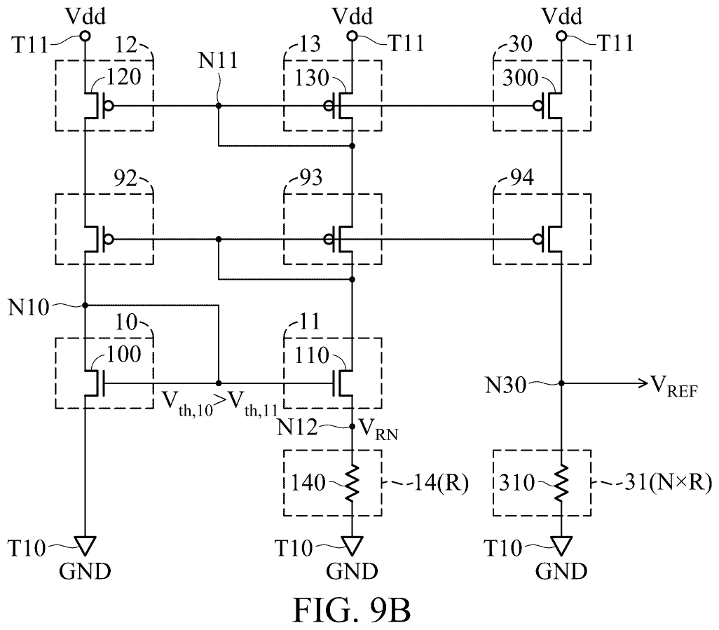

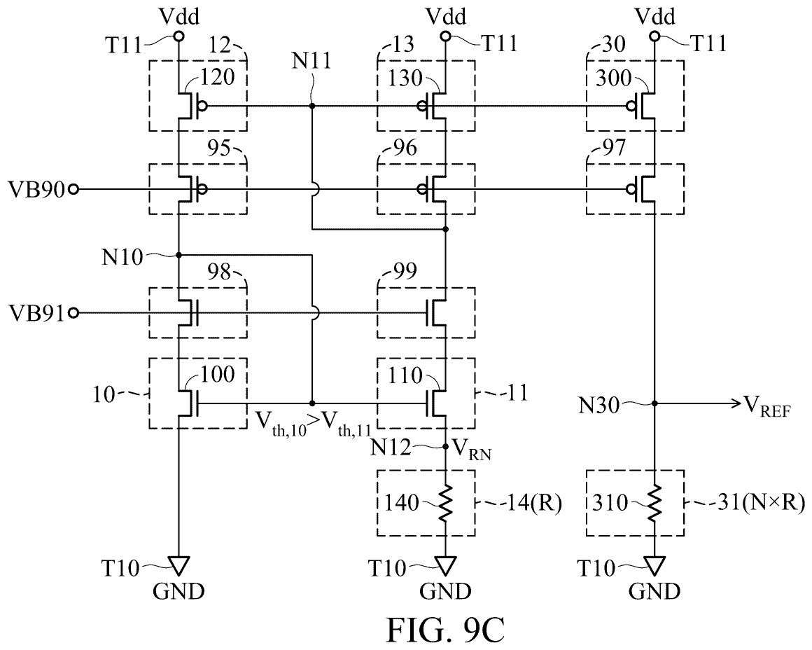

In another embodiment, to obtain the accurate reference voltage VREF, a first-type MOS (such as NMOS) device 90 is cascaded between the second-type MOS (such as PMOS) device 12 and the first-type MOS (such as NMOS) device 10, and a first-type MOS (such as NMOS) device 91 is cascaded between the second-type MOS (such as PMOS) device 13 and the first-type MOS (such as NMOS) device 11, as shown in FIG. 9A.

In another embodiment, to obtain the accurate reference voltage VREF, a second-type MOS (such as PMOS) device 92 is cascaded between the second-type MOS (such as PMOS) device 12 and the first-type MOS (such as NMOS) device 10, a second-type MOS (such as PMOS) device 93 is cascaded between the second-type MOS (such as PMOS) device 13 and the first-type MOS (such as NMOS) device 11, and a second-type MOS (such as PMOS) device 94 is cascaded between the third second-type MOS (such as PMOS) device 30 and the resistive element 31, as shown in FIG. 9B.

In another embodiment, to obtain the accurate reference voltage VREF, the reference circuit 3′ further comprises a high-swing cascade structure between the second-type MOS (such as PMOS) devices 12-13 and the first-type MOS (such as NMOS) devices 10-11. As shown in FIG. 9C, the high-swing cascade structure comprises second-type MOS (such as PMOS) devices 95-97 and first-type MOS (such as NMOS) devices 98 and 99. The second-type MOS (such as PMOS) device 95 and the first-type MOS (such as NMOS) device 98 are cascaded between the second-type MOS (such as PMOS) device 12 and the first-type MOS (such as NMOS) device 10. The second-type MOS (such as PMOS) device 96 and the first-type MOS (such as NMOS) device 99 are cascaded between the second-type MOS (such as PMOS) device 13 and the first-type MOS (such as NMOS) device 11. The second-type MOS (such as PMOS) device 97 is cascaded between the third second-type MOS (such as PMOS) device 30 and the resistive element 31. The second-type MOS (such as PMOS) devices 95-97 are controlled a bias voltage VB90, and the first-type MOS (such as NMOS) devices 98 and 99 are controlled a bias voltage VB91.

In some embodiments, the resistive element 14 in FIGS. 1, 3A, 3B, 4-7 and 9A-9C and the resistive elements 84 and 86 in FIG. 8 may use the structure of the resistive element 14 in FIG. 3C, and the same effect may also be achieved. In some embodiments, the resistive element 31 in FIGS. 3B, 4-7 and 9A-9C may use the structure of the resistive element 31 in FIG. 3C, and the same effect may also be achieved.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A reference circuit, comprising:
a first first-type metal-oxide-semiconductor (MOS) device having a first terminal coupled to a first node, a second terminal coupled to a first voltage supply terminal, and a control terminal coupled to the first node;
a second first-type MOS device having a first terminal coupled to a second node, a second terminal coupled to a third node, and a control terminal coupled to the first node;
a first resistive element coupled between the third node and the first voltage supply terminal;
a first second-type MOS device having a first terminal coupled to a second voltage supply terminal, a second terminal coupled to the first node, a control terminal coupled to the second node; and
a second second-type MOS device having a first terminal coupled to the second voltage supply terminal, a second terminal coupled to the second node, a control terminal coupled to the second node,
wherein a first threshold voltage of the first first-type MOS device is greater than a second threshold voltage of the second first-type MOS device, wherein a difference between a first slope representing variation of the first threshold voltage over temperature and a second slope representing variation of the second threshold voltage over temperature is substantially constant.

2. The reference circuit as claimed in claim 1, wherein:
the first first-type MOS device comprises a first N-type MOS (NMOS) transistor, and the first NMOS transistor has a drain, a source, and a gate which are coupled to the first terminal, the second terminal, and the control terminal of the first first-type MOS device respectively,
the second first-type MOS device comprises a second NMOS transistor, and the second NMOS transistor has a drain, a source, and a gate which are coupled to the first terminal, the second terminal, and the control terminal of the second first-type MOS device respectively,
the first second-type MOS device comprises a first P-type MOS (PMOS) transistor, and the first PMOS transistor has a source, a drain, and a gate which are coupled to the first terminal, the second terminal, and the control terminal of the first second-type MOS device respectively, and
the second second-type MOS device comprises a second PMOS transistor, and the second PMOS transistor has a source, a drain, and a gate which are coupled to the first terminal, the second terminal, and the control terminal of the second second-type MOS device respectively;
wherein the second voltage supply terminal is configured to receive an operating voltage, and the first voltage supply terminal is coupled to a ground.

3. The reference circuit as claimed in claim 1, wherein:
the first first-type MOS device comprises a first P-type MOS (PMOS) transistor, and the first PMOS transistor has a drain, a source, and a gate which are coupled to the first terminal, the second terminal, and the control terminal of the first first-type MOS device respectively,
the second first-type MOS device comprises a second PMOS transistor, and the second PMOS transistor has a drain, a source, and a gate which are coupled to the first terminal, the second terminal, and the control terminal of the second first-type MOS device respectively,
the first second-type MOS device comprises a first N-type MOS (NMOS) transistor, and the first NMOS transistor has a source, a drain, and a gate which are coupled to the first terminal, the second terminal, and the control terminal of the first second-type MOS device respectively, and
the second second-type MOS device comprises a second NMOS transistor, and the second NMOS transistor has a source, a drain, and a gate which are coupled to the first terminal, the second terminal, and the control terminal of the second second-type MOS device respectively;
wherein the first voltage supply terminal is configured to receive an operating voltage, and the second voltage supply terminal is coupled to a ground.

4. The reference circuit as claimed in claim 1, wherein:
the first first-type MOS device comprises a first first-type MOS transistor, and multiple pairs of one switch and one second first-type MOS transistor,
wherein the plurality pairs of one switch and one second first-type MOS transistor are coupled in parallel between the first node and the first voltage supply terminal;
wherein for each of the plurality pairs of one switch and one second first-type MOS transistor:
the switch and the second first-type MOS transistor are coupled in series between the first node and the first voltage supply terminal, and
the second first-type MOS transistor has a control terminal coupled to the control terminal of the first first-type MOS transistor.

5. The reference circuit as claimed in claim 1, wherein:
the second first-type MOS device comprises a first first-type MOS transistor, and multiple pairs of one switch and one second first-type MOS transistor,
wherein the plurality pairs of one switch and one second first-type MOS transistor are coupled in parallel between the second node and the first voltage supply terminal,
wherein for each of the plurality pairs of one switch and one second first-type MOS transistor:
the switch and the second first-type MOS transistor are coupled in series between the second node and the first voltage supply terminal, and
the second first-type MOS transistor has a control terminal coupled to the control terminal of the first first-type MOS transistor.

6. The reference circuit as claimed in claim 1, further comprising:
a third second-type MOS device having a first terminal coupled to the second voltage supply terminal, a second terminal coupled to a fourth node, a control terminal coupled to the second node; and
a second resistive element coupled between the fourth node and the first voltage supply terminal,
wherein a first reference voltage is generated from the third node, and/or a second reference voltage is generated from the fourth node.

7. The reference circuit as claimed in claim 6, wherein:
the first resistive element has a first resistance value, and the second resistive element has a second resistance value, and
the second resistance value is N times the first resistance value.

8. The reference circuit as claimed in claim 6, wherein the second resistive element comprises:
a first resistor coupled between the fourth node and the first voltage supply terminal; and
a plurality pairs of one switch and one second resistor,
wherein plurality pairs of one switch and one second resistor are coupled in parallel between the fourth node and the first voltage supply terminal,
wherein for each of the plurality pairs of one switch and one second resistor:
the switch and the second resistor are coupled in series between the fourth node and the first voltage supply terminal.

9. The reference circuit as claimed in claim 8, wherein a total resistance value of the second resistive element is determined such that the second reference voltage is within a predetermined voltage range within a predetermined temperature range.

10. The reference circuit as claimed in claim 8, wherein:
the second resistive element has a second resistance value, and
the second resistance value is determined according to a resistance value of the first resistor and a total resistance value of at least one second resistor coupled to the turned-on switch.

11. The reference circuit as claimed in claim 8, wherein the first first-type MOS device comprises a first first-type MOS transistor and multiple pairs of one switch and one second first-type MOS transistor,
wherein the plurality pairs of one switch and one second first-type MOS transistor are coupled in parallel between the first node and the first voltage supply terminal;
wherein for each of the plurality pairs of one switch and one second first-type MOS transistor:
the switch and the second first-type MOS transistor are coupled in series between the first node and the first voltage supply terminal, and
the second first-type MOS transistor has a control terminal coupled to the control terminal of the first first-type MOS transistor.

12. The reference circuit as claimed in claim 11, wherein the first slope representing variation of the first threshold voltage over temperature is determined according to size of the first first-type MOS transistor and size of at least one second first-type MOS transistor coupled to the turned-on switch.

13. The reference circuit as claimed in claim 6, wherein the first first-type MOS device comprises: a first first-type MOS transistor and multiple pairs of one switch and one second first-type MOS transistor,
wherein the plurality pairs of one switch and one second first-type MOS transistor are coupled in parallel between the first node and the first voltage supply terminal;
wherein for each of the plurality pairs of one switch and one second first-type MOS transistor:
the switch and the second first-type MOS transistor are coupled in series between the first node and the first voltage supply terminal, and
the second first-type MOS transistor has a control terminal coupled to the control terminal of the first first-type MOS transistor.

14. The reference circuit as claimed in claim 1, wherein a ratio of the size of the first first-type MOS device to the size of the second first-type MOS device is a value greater than 1 or substantially equal to 1.

15. The reference circuit as claimed in claim 1, further comprising:
a third second-type MOS device having a first terminal coupled to the second voltage supply terminal, a second terminal configured to generate a reference current, a control terminal coupled to the second node.

16. The reference circuit as claimed in claim 1, further comprising:
a third first-type MOS device having a first terminal coupled to the second terminal of the first second-type MOS device at a fourth node, a second terminal coupled to the first terminal of the first first-type MOS device at the first node, and a control terminal coupled to the fourth node; and
a fourth first-type MOS device having a first terminal coupled to the second terminal of the second second-type MOS device at the second node, a second terminal coupled to the first terminal of the second first-type MOS device, and a control terminal coupled to the fourth node.

17. The reference circuit as claimed in claim 1, further comprising:
a third second-type MOS device having a first terminal coupled to the second terminal of the first second-type MOS device, a second terminal coupled to the first terminal of the first first-type MOS device at the first node, and a control terminal coupled to a fourth node; and
a fourth second-type MOS device having a first terminal coupled to the second terminal of the second second-type MOS device at the second node, a second terminal coupled to the first terminal of the second first-type MOS device at the fourth node, and a control terminal coupled to the fourth node.

18. The reference circuit as claimed in claim 6, wherein the first reference voltage is insensitive to temperature.

19. The reference circuit as claimed in claim 1, wherein the first threshold voltage and the second threshold voltage complementary to absolute temperature (CTAT); or
the first first-type MOS device and the second first-type MOS device are transistors of different threshold types manufactured in an advanced process.

20. The reference circuit as claimed in claim 1, wherein the first resistive element comprises a first switch, a second switch and a capacitor, wherein the first switch and the capacitor are coupled in series between the third node and the first voltage supply terminal, and the second switch is coupled in parallel with the capacitor, with one terminal of the second switch coupled to the first voltage supply terminal.
